(19) United States
(12) Patent Application Publication
(10) Pub. No.: US 2025/0192924 A1
(43) Pub. Date: Jun. 12, 2025

(54) RULE-BASED SOFT BUFFER MANAGEMENT

(71) Applicant: QUALCOMM Incorporated, San Diego, CA (US)

(72) Inventors: Jing SUN, San Diego, CA (US); Jing JIANG, San Diego, CA (US); Mostafa KHOSHNEVISAN, San Diego, CA (US); Ahmed Abdelaziz Ibrahim Abdelaziz ZEWAIL, San Diego, CA (US); Yi HUANG, San Diego, CA (US); Junyi LI, Fairless Hills, PA (US); Kianoush HOSSEINI, San Diego, CA (US)

(21) Appl. No.: 18/536,021

(22) Filed: Dec. 11, 2023

(51) Int. Cl. H04L 1/1829

(52) U.S. Cl. CPC H04L 1/1835

(57) ABSTRACT

Methods, systems, and devices for wireless communications are described. The techniques described herein relate to rule-based soft buffer management. A user equipment (UE) attempts to decode a transport block (TB) received at the UE from a network entity. The UE stores in a buffer, based on occurrence of a decoding failure during decoding of the TB, information from the TB. The UE applies a buffer management rule to manage capacity of the buffer. The buffer management rule is common to both the UE and the network entity. The UE transmits one or more negative acknowledgment (NACK) messages to the network entity, the one or more NACK messages indicative of the decoding failure of the TB. The UE receives an additional TB responsive to the one or more NACK messages and in accordance with the buffer management rule.

### FIELD OF TECHNOLOGY

The following relates to wireless communications, including rule-based soft buffer management.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications systems may support soft buffers for combining retransmissions for reliable data transmissions. Because the soft buffers at a UE have a limited size, the content of the soft buffers is actively managed by the UE. The rules applied by the UE in managing the soft buffers may not be known at a network entity (e.g., a base station) in communication with the UE.

### SUMMARY

The described techniques relate to improved methods, systems, devices, and apparatuses that support rule-based soft buffer management. A user equipment (UE) may receive an indication of one or more rules for managing a soft buffer and the network entity may provide a retransmission of transport blocks (TBs) in a hybrid automatic repeat request (HARQ) procedure with knowledge of one or more rules. The one or more rules may include allocating a shared resource pool (rather than individual ones) of the buffer for multiple component carriers. The one or more rules may include a time-based buffer purging of TBs where TBs are removed upon expiration of a timer so that new TBs may be stored in the buffer (e.g., in a first-in-first-out (FIFO) manner). The one or more rules may include a size-based buffer purging of TBs where TBs are removed upon exceeding a threshold quantity of TBs in the buffer so that new TBs may be stored in the buffer. The one or more rules may include priority levels associated with respective TBs. In such examples, the priority levels may be associated with expiration timers, such that different priority levels are associated with different expiration timers. Portions of the storage buffer may be allocated to different priority levels (e.g., a first portion of the buffer for a first priority level and a second portion of the buffer for a second priority level) and the buffer may be dynamically allocated between the first portion and the second portion. The one or more rules may be used individually or in combination to manage the soft buffer of the UE. The network entity having knowledge of the one or more rules may allow the network entity to more accurately predict and efficiently retransmit the TBs that the UE did not decode or receive in the initial transmission during the HARQ procedure.

A method for wireless communication by a UE is described. The method may include attempting to decode a TB received at the UE from a network entity, storing in a buffer, based on occurrence of a decoding failure during decoding of the TB, information from the TB, applying a buffer management rule to manage capacity of the buffer, where the buffer management rule is common to both the UE and the network entity, transmitting one or more NACK messages to the network entity, the one or more NACK messages indicative of the decoding failure of the TB, and receiving an additional TB responsive to the one or more NACK messages and in accordance with the buffer management rule.

A UE for wireless communication is described. The UE may include one or more memories storing processor executable code, and one or more processors coupled with the one or more memories. The one or more processors may individually or collectively operable to execute the code to cause the UE to attempt to decode a TB received at the UE from a network entity, store in a buffer, based on occurrence of a decoding failure during decoding of the TB, information from the TB, apply a buffer management rule to manage capacity of the buffer, where the buffer management rule is common to both the UE and the network entity, transmit one or more NACK messages to the network entity, the one or more NACK messages indicative of the decoding failure of the TB, and receive an additional TB responsive to the one or more NACK messages and in accordance with the buffer management rule.

Another UE for wireless communication is described. The UE may include means for attempting to decode a TB received at the UE from a network entity, means for storing in a buffer, based on occurrence of a decoding failure during decoding of the TB, information from the TB, means for applying a buffer management rule to manage capacity of the buffer, where the buffer management rule is common to both the UE and the network entity, means for transmitting one or more NACK messages to the network entity, the one or more NACK messages indicative of the decoding failure of the TB, and means for receiving an additional TB responsive to the one or more NACK messages and in accordance with the buffer management rule.

A non-transitory computer-readable medium storing code for wireless communication is described. The code may include instructions executable by one or more processors to attempt to decode a TB received at the UE from a network entity, store in a buffer, based on occurrence of a decoding failure during decoding of the TB, information from the TB, apply a buffer management rule to manage capacity of the buffer, where the buffer management rule is common to both the UE and the network entity, transmit one or more NACK messages to the network entity, the one or more NACK messages indicative of the decoding failure of the TB, and receive an additional TB responsive to the one or more NACK messages and in accordance with the buffer management rule.

In some examples of the method, UEs, and non-transitory computer-readable medium described herein, resources allocated to the buffer include a shared resource pool that may be available for storage that pertains to a set of multiple component carriers in carrier aggregation.

In some examples of the method, UEs, and non-transitory computer-readable medium described herein, the buffer management rule indicates that the buffer may be associated with a timer-based storage of TBs and an individual TB may be removed from the buffer after the timer expires for the individual TB.

In some examples of the method, UEs, and non-transitory computer-readable medium described herein, the timer begins at a reference time that may be associated with one of receipt of a downlink control information message that schedules the one or more TBs, transmission of the TB, or an ACK or NACK reporting time for the TB.

Some examples of the method, UEs, and non-transitory computer-readable medium described herein may further include operations, features, means, or instructions for receiving a value of the timer via a RRC message.

Some examples of the method, UEs, and non-transitory computer-readable medium described herein may further include operations, features, means, or instructions for transmitting a capability of the UE, where the capability may be associated with management of the buffer at the UE, and where the value of the timer may be based on the capability.

In some examples of the method, UEs, and non-transitory computer-readable medium described herein, the buffer management rule indicates that the buffer may be associated with a buffer size threshold for storage of TBs and an individual TB may be removed from the buffer based on the buffer size threshold being exceeded and based on a relative time duration of the individual TBs in the buffer with respect to other individual TBs in the buffer.

In some examples of the method, UEs, and non-transitory computer-readable medium described herein, the buffer management rule indicates that the buffer may be associated with a priority-based storage of TBs, where a purging of individual TBs from the buffer may be based on respective priorities of the individual TBs.

Some examples of the method, UEs, and non-transitory computer-readable medium described herein may further include operations, features, means, or instructions for receiving indications of the respective priorities via respective downlink control information messages that schedule the individual TBs.

In some examples of the method, UEs, and non-transitory computer-readable medium described herein, the buffer management rule further indicates that the buffer may be associated with a timer-based storage of TBs, where the purging of individual TBs from the buffer may be based on a duration of the individual TB in the buffer in combination with the respective priorities.

In some examples of the method, UEs, and non-transitory computer-readable medium described herein, a buffer storage allocation of the buffer may be allocated based on different priority levels that include at least a first priority level and a second priority level, where a first portion of the buffer may be allocated for the first priority level and a second portion of the buffer may be allocated for the second priority level.

Some examples of the method, UEs, and non-transitory computer-readable medium described herein may further include operations, features, means, or instructions for receiving an indication of the buffer storage allocation indicative of the first portion and the second portion.

Some examples of the method, UEs, and non-transitory computer-readable medium described herein may further include operations, features, means, or instructions for allocating the buffer storage allocation dynamically between the first portion and the second portion.

Some examples of the method, UEs, and non-transitory computer-readable medium described herein may further include operations, features, means, or instructions for receiving control signaling from the network entity indicating the buffer management rule for managing the buffer.

A method for wireless communication by a network entity is described. The method may include transmitting a TB to a UE over a downlink shared channel, receiving one or more NACK messages, the one or more NACK messages associated with the TB, determining, based on receipt of the one or more NACK messages, that information from the TB is stored at a buffer at the UE based on a buffer management rule that is common to both the network entity and the UE; an, and transmitting, to the UE, an additional TB responsive to the one or more NACK messages and in accordance with the buffer management rule.

A network entity for wireless communication is described. The network entity may include one or more memories storing processor executable code, and one or more processors coupled with the one or more memories. The one or more processors may individually or collectively operable to execute the code to cause the network entity to transmit a TB to a UE over a downlink shared channel, receive one or more NACK messages, the one or more NACK messages associated with the TB, determine, based on receipt of the one or more NACK messages, that information from the TB is stored at a buffer at the UE based on a buffer management rule that is common to both the network entity and the UE; an, and transmit, to the UE, an additional TB responsive to the one or more NACK messages and in accordance with the buffer management rule.

Another network entity for wireless communication is described. The network entity may include means for transmitting a TB to a UE over a downlink shared channel, means for receiving one or more NACK messages, the one or more NACK messages associated with the TB, means for determining, based on receipt of the one or more NACK messages, that information from the TB is stored at a buffer at the UE based on a buffer management rule that is common to both the network entity and the UE; an, and means for transmitting, to the UE, an additional TB responsive to the one or more NACK messages and in accordance with the buffer management rule.

A non-transitory computer-readable medium storing code for wireless communication is described. The code may include instructions executable by one or more processors to transmit a TB to a UE over a downlink shared channel, receive one or more NACKmessages, the one or more NACK messages associated with the TB, determine, based on receipt of the one or more NACK messages, that information from the TB is stored at a buffer at the UE based on a buffer management rule that is common to both the network entity and the UE; an, and transmit, to the UE, an additional TB responsive to the one or more NACK messages and in accordance with the buffer management rule.

In some examples of the method, network entities, and non-transitory computer-readable medium described herein, the buffer management rule indicates that the buffer may be associated with a timer-based storage of TBs, where purging of the buffer may be based on a duration of individual TBs in the buffer with respect to a timer.

Some examples of the method, network entities, and non-transitory computer-readable medium described herein may further include operations, features, means, or instructions for transmitting a value of the timer via a RRC message.

Some examples of the method, network entities, and non-transitory computer-readable medium described herein may further include operations, features, means, or instructions for receiving a capability of the UE, where the capability may be associated with management of the buffer at the UE, and where the value of the timer may be based on the capability.

In some examples of the method, network entities, and non-transitory computer-readable medium described herein, the buffer management rule indicates that the buffer may be associated with a buffer size threshold for storage of TBs, where purging of the buffer may be based on the buffer size threshold being exceeded and based on a relative time duration of individual TBs in the buffer with respect to other individual TBs in the buffer.

In some examples of the method, network entities, and non-transitory computer-readable medium described herein, the buffer management rule indicates that the buffer may be associated with a priority-based storage of TBs, where a purging of individual TBs from the buffer may be based on respective priorities of the individual TBs.

Some examples of the method, network entities, and non-transitory computer-readable medium described herein may further include operations, features, means, or instructions for transmitting indications of the respective priorities via respective downlink control information messages that schedule the individual TBs.

In some examples of the method, network entities, and non-transitory computer-readable medium described herein, the buffer management rule further indicates that the buffer may be associated with a timer-based storage of TBs, where the purging of individual TBs from the buffer may be based on a duration of the individual TBs in the buffer in combination with the respective priorities.

In some examples of the method, network entities, and non-transitory computer-readable medium described herein, a buffer storage allocation of the buffer may be allocated based on different priority levels that include at least a first priority level and a second priority level, where a first portion of the buffer may be allocated for the first priority level and a second portion of the buffer may be allocated for the second priority level.

Some examples of the method, network entities, and non-transitory computer-readable medium described herein may further include operations, features, means, or instructions for transmitting an indication of the buffer storage allocation indicative of the first portion and the second portion.

Some examples of the method, network entities, and non-transitory computer-readable medium described herein may further include operations, features, means, or instructions for transmitting control signaling from the network entity indicating the buffer management rule for managing the buffer.

### BRIEF DESCRIPTION OF THE DRAWINGS

FIG. 1 shows an example of a wireless communications system that supports rule-based soft buffer management in accordance with one or more aspects of the present disclosure.

FIG. 2 shows an example of a wireless communications system that supports rule-based soft buffer management in accordance with one or more aspects of the present disclosure.

FIG. 3 shows an example of a process flow that supports rule-based soft buffer management in accordance with one or more aspects of the present disclosure.

FIGS. 4 and 5 show block diagrams of devices that support rule-based soft buffer management in accordance with one or more aspects of the present disclosure.

FIG. 6 shows a block diagram of a communications manager that supports rule-based soft buffer management in accordance with one or more aspects of the present disclosure.

FIG. 7 shows a diagram of a system including a device that supports rule-based soft buffer management in accordance with one or more aspects of the present disclosure.

FIGS. 8 and 9 show block diagrams of devices that support rule-based soft buffer management in accordance with one or more aspects of the present disclosure.

FIG. 10 shows a block diagram of a communications manager that supports rule-based soft buffer management in accordance with one or more aspects of the present disclosure.

FIG. 11 shows a diagram of a system including a device that supports rule-based soft buffer management in accordance with one or more aspects of the present disclosure.

FIGS. 12 through 15 show flowcharts illustrating methods that support rule-based soft buffer management in accordance with one or more aspects of the present disclosure.

### DETAILED DESCRIPTION

Some wireless communications systems may support soft buffers for combining retransmissions for reliable data transmissions. For example, a user equipment (UE) in a hybrid automatic repeat request (HARQ) procedure may receive an initial transmission of transport blocks (TBs) from a network entity. Information in the initial transmission may be encoded, and the UE may decode the received TBs to recover the information. If any TBs are not received by the UE or the UE is unable to decode them, the UE may store the received TBs in a buffer for combining with TBs received in a retransmission. However, the memory for storage in the buffer of the UE may be limited, such that a limited quantity of TBs may be stored in the buffer. To manage TB storage in the buffer, the UE may follow one or more UE-implemented rules. For example, the UE may store fewer TBs than the TBs in the HARQ procedure (e.g., store 8 HARQ IDs out of 16 HARQ IDs) by removing the other TBs (e.g., in accordance with a UE-implemented rule or even by arbitrary removal by the UE). Because the UE is following its own rules in performing buffer management, the network entity may not have knowledge of which TBs are stored and which TBs have been removed, and thus, may not know which TBs to transmit in the retransmission. Without knowledge of which TBs are presently stored in the buffer of the UE, the network entity may transmit more TBs than may be needed by the UE, resulting in a performance loss at the UE and/or the network entity.

The UE may receive an indication of one or more rules for managing the soft buffer and the network entity may provide a retransmission with knowledge of the one or more rules. The one or more rules may include allocating a shared resource pool (rather than individual ones) of the buffer for multiple component carriers. The one or more rules may include a time-based buffer purging of TBs where TBs are removed upon expiration of a timer so that new TBs may be stored in the buffer (e.g., in a first-in-first-out (FIFO) manner). The one or more rules may include a size-based buffer purging of TBs where TBs are removed upon exceeding a threshold quantity of TBs in the buffer so that new TBs may be stored in the buffer. The one or more rules may include priority levels associated with respective TBs. In such examples, the priority levels may be associated with expiration timers, such that different priority levels are associated with different expiration timers. Portions of the storage buffer may be allocated to different priority levels (e.g., a first portion of the buffer for a first priority level and a second portion of the buffer for a second priority level) and the buffer may be dynamically allocated between the first portion and the second portion. The one or more rules may be used individually or in combination to manage the soft buffer of the UE. The network entity having knowledge of the one or more rules may allow the network entity to more accurately predict and efficiently retransmit the TBs that the UE did not decode or receive in the initial transmission during the HARQ procedure.

Aspects of the disclosure are initially described in the context of wireless communications systems. Aspects of the disclosure are further illustrated by and described with reference to apparatus diagrams, system diagrams, and flowcharts that relate to rule-based soft buffer management.

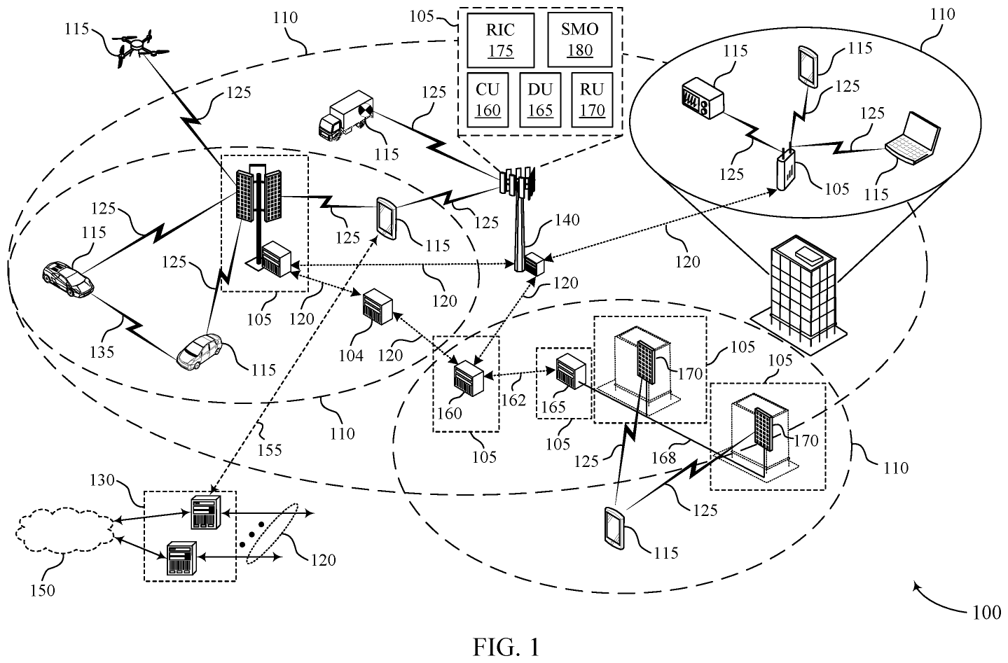

FIG. 1 shows an example of a wireless communications system 100 that supports rule-based soft buffer management in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (cNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support rule-based soft buffer management as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHZ), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. The HARQ feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Additionally, as part of a HARQ procedure, the UE 115 may receive an initial transmission of encoded TBs from the network entity 105, and the UE 115 may decode the received TBs to recover information. In some examples, the UE 115 may not receive some TBs or may be unable to decode them. The UE 115 may store the received TBs in a soft buffer for combining with TBs received in a retransmission of TBs from the network entity 105. To manage TB storage in the buffer, the UE 115 may follow one or more UE-implemented rules or perform arbitrary management. Because the UE 115 is following its own rules in performing buffer management, the network entity 105 may not have knowledge of which TBs are stored and which TBs have been removed, and thus, may not know which TBs to transmit in the retransmission. Without knowledge of which TBs are presently stored in the buffer of the UE 115, the network entity 105 may transmit more TBs than may be needed by the UE 115, resulting in a performance loss at the UE 115 and/or the network entity 105.

As discussed herein, the UE 115 may receive an indication of one or more rules for managing the soft buffer and the network entity 105 may provide a retransmission with knowledge of the one or more rules. In some examples, the UE 115 may receive the indication of the one or more rules from the network entity 105 or the UE 115 may provide an indication of the one or more rules to the network entity 105 (if received from another entity), such that the network entity 105 has knowledge of the one or more rules.

The one or more rules may include allocating a shared resource pool (rather than individual ones) of the buffer for multiple component carriers. The one or more rules may include a time-based buffer purging of TBs where TBs are removed upon expiration of a timer so that new TBs may be stored in the buffer (e.g., in FIFO manner). The one or more rules may include a size-based buffer purging of TBs where TBs are removed upon exceeding a threshold quantity of TBs in the buffer so that new TBs may be stored in the buffer. The one or more rules may include priority levels associated with respective TBs. In such examples, the priority levels may be associated with expiration timers, such that different priority levels are associated with different expiration timers. Portions of the storage buffer may be allocated to different priority levels (e.g., a first portion of the buffer for a first priority level and a second portion of the buffer for a second priority level) and the buffer may be dynamically allocated between the first portion and the second portion. The one or more rules may be used individually or in combination to manage the soft buffer of the UE 115. The network entity 105 having knowledge of the one or more rules may allow the network entity 105 to more accurately predict and efficiently retransmit the TBs that the UE 115 did not decode or receive in the initial transmission during the HARQ procedure.

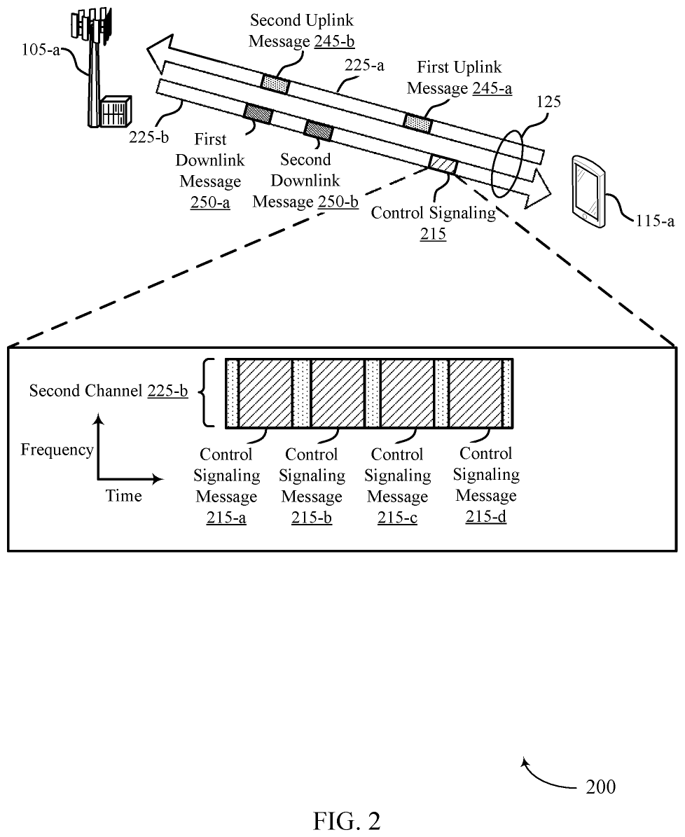

FIG. 2 shows an example of a wireless communications system 200 that supports rule-based soft buffer management in accordance with one or more aspects of the present disclosure. The wireless communications system 200 may implement aspects of or may be implemented by aspects of the wireless communications system 100. For example, the wireless communications system 200 includes a UE 115-a and a network entity 105-a, which may be examples of a UE 115 described with respect to FIG. 1. Although the following discussions describe the UE 115-a receiving the indication of the one or more rules form the network entity 105-a, the UE 115 may receive the indication of the one or more rules from another entity (e.g., another device in the wireless communications system 200) or the UE 115-a may store the one or more rules prior to performing the HARQ procedure (e.g., and may transmit the indication to the network entity 105-a for knowledge of the one or more rules).

In some examples, the UE 115-a may include a soft buffer to store a log-likelihood ratio (LLR) for downlink TBs to support soft combining in retransmission of the TBs. For example, the UE 115-a may receive the initial transmission of encoded TBs from the network entity 105-a, and the UE 115-a may decode the received TBs to recover information. In some examples, the UE 115-a may not receive some TBs or may be unable to decode them. The UE 115-a may store the LLRs for the TBs in the soft buffer. However, the soft buffer may be a limited resource, for example, since there may be a high cost (e.g., financial and/or space) associated with memory for the soft buffer. Additionally, maintaining a larger memory may be associated with greater power consumption. In some examples, managing the memory of the buffer may involve the UE 115-a storing fewer TBs (e.g., soft buffer pages) than the TBs in the HARQ procedure (e.g., quantity of TBs the network entity 105-a uses for the HARQ procedure) (e.g., store 8 HARQ IDs out of 16 HARQ IDs). Such management may be UE-implemented, for example, where the UE 115-a determines which TBs (e.g., HARQ processes) are to be removed from the buffer. Accordingly, network entity 105-a may not have knowledge of which TBs associated with a previously-received negative acknowledgment (NACK) may be stored in the buffer for subsequent combination with TBs of the retransmission.

The UE-implemented soft buffer management may be sufficient for some LTE and NR communications, but the network entity 105-a may not have knowledge of exactly which TB with a previous NACK will be stored in the soft buffer. Not having knowledge of which TB is stored or will be stored in the soft buffer may further reduce performance and efficiency for the HARQ procedure if the quantity of TBs (e.g., quantity of soft buffer pages) is substantially lower than the quantity of TBs in the retransmission (e.g., quantity of HARQ process IDs).

Rather than using the UE-implemented soft buffer management, and as discussed herein, the UE 115-a may use one or more rules to manage the soft buffer, where the network entity 105-a has knowledge (e.g., better knowledge) of which one or more TBs are stored in the soft buffer. Accordingly, the network entity 105-a may strategically, with knowledge, retransmit the TBs that may be combined with the stored TBs in order to ensure reliable transmission of information (e.g., including all the TBs intended in the initial transmission) to the UE 115-a. In some examples, the network entity 105-a may not know exactly which TBs are in the soft buffer, for example, based on downlink control information (DCI) miss detection and HARQ acknowledgment (ACK) codebook (CB) missing error events. However, knowledge of the rules implemented by the UE for managing the soft buffer may provide an indication of which TBs are likely stored in the soft buffer, as well as make better scheduling decisions. The network entity 105 may retransmit TBs based on predicting which TBs are likely stored in the soft buffer.

In the wireless communication system 200, the UE 115-a and the network entity 105-a may communicate to perform rule-based buffer management. The network entity 105-a may communicate with the UE 115-a using a communication link 125. In some examples, the communication link 125 may include a first channel 225-a for transmitting data from the UE 115-a to the network entity 105-a and a second channel 225-b for transmitting data from the network entity 105-a to the UE 115-a. The communication link 125 may be an example of an NR or LTE link between the UE 115-a and the network entity 105-a. The communication link 125 may include a bi-directional link that enables both uplink and downlink communications, for example, via the channels 225. For example, the UE 115-a may transmit uplink messages 245 (e.g., uplink transmissions), such as uplink control signals or uplink data signals, to the network entity 105-a using the first channel 225-a (e.g., of the communication link 125) and the network entity 105-a may transmit downlink messages 250 (e.g., downlink transmissions), such as downlink control signals or downlink data signals, to the UE 115-a using the second channel 225-b (e.g., of the communication link 125).

During a HARQ procedure, the network entity 105-a may transmit a first downlink message 250-a (e.g., over the second channel 225-b or physical downlink shared channel (PDSCH)), which may include encoded TBs as part of a HARQ process. The UE 115-a may transmit a first uplink message 245-a (e.g., over the first channel 225-a, physical uplink shared channel (PDUCH), or physical uplink control channel (PUCCH)) that indicates HARQ feedback, such as an ACK or NACK message. The first uplink message 245-a may include an ACK when all the TBs are received and the UE 115-a is able to decode them, indicating that the TBs were received as expected and decoded without error. However, when the UE 115-a in unable to decode one or more of the TBs, the UE 115-a may store them in the soft buffer of the UE 115-a and the first uplink message 245-a may include a NACK. The network entity 105-a may retransmit the TBs in a second downlink message 250-b in response to receiving the NACK in the first uplink message 245-a, to increase the likelihood of successful decoding by the UE 115-a. The network entity 105-a may predict which TBs are stored in the buffer, which TBs have been removed from the buffer, or both, based on the one or more rules. For example, the network entity 105-a may transmit control signaling 215, which may include an indication of the one or more rules to be implemented by the UE 115-a. In some examples, when the network entity 105-a does not provide an indication of the rules, the UE 115-a may transmit the second uplink message 245-b indicating the one or more rules to the network entity 105-a. In this manner, the network entity 105-a has knowledge of the one or more rules, which may enable the network entity 105-a to more accurately predict and efficiently retransmit the TBs in the second downlink message 250-b. The TBs in the second downlink message 250-b may include TBs that the UE 115-a did not successfully decode in the initial transmission from the first downlink message 250-a.

Although the control signaling 215 discussed herein is described as including multiple messages corresponding to respective rules, a single instance of control signaling or a single message may be used to convey the one or more rules (e.g., all the rules are combined into a single message and transmitted via control signaling 215 to the UE 115-a). In some examples, the network entity 105-a may transmit the control signaling 215 to the UE 115-a over the communication link 125 (e.g., over the second channel 225-b). In some examples, the control signaling 215 may include scheduled control signaling message 215-a, 215-b, 215-c, and 215-d in a time and/or frequency resource. The UE 115-a may receive the control signaling 215 including the control signaling message 215-a, which includes a rule to share the soft buffer across multiple component carriers, resulting in better trunking gain since greater utilization is possible with larger buffer storage. Instead of allocating resources for soft buffers or a soft buffer separately for different component carriers, the soft buffer may be allocated to all component carriers. For example, the buffer storage space that may be allocated per component carrier may be combined into a single shared resource pool for all the component carriers. As an example, if the soft buffer includes 16 pages to support 4 component carriers, then 4 pages may be allocated per component carrier (e.g., storage for 4 TBs in error for each component carrier) without the rule. In this example, if more than 4 TBs in a component carrier are received or decoded in error, soft combining may not be provided for the additional TBs since the buffer allocation is limited to 4 pages per component carrier. However, by implementing shared allocation of the soft buffer (e.g., shared soft buffer pages), more than 4 TBs in a component carrier that are in error may be supported as long as the total number of TBs in error is less than 16 (e.g., regardless of the carrier).

The control signaling message 215-b may include a rule to purge the buffer based on a timer (e.g., time-based soft buffer purge). The TBs may be removed from the soft buffer based on a threshold time. In some examples, a timer may be defined in slot or symbol units of time. The rule may involve defining X, in slots/symbols, where a TB is to be received after X for storage. For example, if a TB is received in X slots before a reference time (e.g., present time, such that X is a threshold quantity of slots or symbols before the present time), then the TB may be removed (e.g., flushed) from the soft buffer. The TB being received before X may indicate that the TB was received in a slot before X and has been stored for too long (e.g., may no longer be relevant) to be used for retransmission with soft combining. The X timer may be based on a UE implementation or via RRC configuring, for example, based on a UE capability. If X is RRC-configured, such that the network entity 105-a may likely define X, a reference time may be included to count the X slots. The reference time may be the DCI time (that schedules the TB) (starting symbol, ending symbol, the slot the DCI is transmitted, etc.). In some examples, the reference time may be the TB transmission time (starting symbol, ending symbol, the slot that the TB is transmitted, etc.). In some examples, the reference time may be the ACK/NACK (A/N) reporting time for the TB (starting symbol, ending symbol, the slot the A/N is transmitted, etc.). The time-based soft buffer purge may be more useful when there are different priorities associated with the TBs or based on Quality of Service (QOS) of the TBs, as discussed herein.

The control signaling message 215-c may include a rule to purge the buffer based on a buffer size (e.g., size-based soft buffer purge). The TBs may be removed from the soft buffer based on a threshold buffer size. When the quantity of TBs in error exceeds a threshold quantity (e.g., a maximum quantity) of soft buffer pages available, the UE 115-a may purge some pages to make space for the newly received TBs. Accordingly, when the soft buffer has reached capability (e.g., 16 pages are full), then the UE 115-a may expire and remove the oldest TB in the soft buffer.

The control signaling message 215-d may include a rule to purge the buffer based on a priority associated with the TB. For example, different transmissions may be associated with different priorities. The rule may define priority for different PDSCH (e.g., multiple TBs in the transmission) or an individual TB, and the UE 115-a may manage the soft buffer to provide different QoS. For example, some data or TBs may be transmitted with greater reliability than other data or associated with lower reliability, such that the rule may include storing the TB associated with greater reliability in the buffer for a relatively longer duration than for data or TB associated with the lower reliability. Some data or TB may be transmitted with relatively lower latency than other data or TB associated, and thus, the TB or data associated with the relatively lower latency may not be stored in the buffer for more than a threshold duration. In some examples, the priority level of a TB may be indicated in the DCI granting the TB, and the UE 115-a may use the priority to manage the TB and the soft buffer.

The one or more rules may applied individually or as a combination. For example, different expiration time X may be applied for different priority levels (e.g., per priority level configuration). In some examples, the rule may support prioritization for soft buffer usage (e.g., different priority levels sharing the same soft buffer). The soft buffer may be divided by a semi-static split between priorities or a dynamic share across priorities. In the semi-static split between priorities, the buffer size, Z, may be separated for different priorities, such that the priority-based buffer size includes Z0 (e.g., buffer size for first priority), Z1 (buffer size for second priority), and so forth. The different QoS may be characterized by setting different Zs (e.g., different buffer sizes or portions of a buffer) for different priorities (e.g., greater Z value corresponding to a relatively higher priority).

In the dynamic share across priorities, the buffer size, Z, may be separated for different priorities, which may be dynamic priorities. For example, a TB with priority 0 may have a higher priority to access the soft buffer than a TB with priority 1, where the TBs may have a priorities of 0 or 1 and a priority of 0 is a higher priority. The total soft buffer size may be Z, the high priority may correspond to Z0 (e.g., portion of Z dedicated to high priority), and the low priority may correspond to Z1 (e.g., portion of Z dedicated to low priority). The UE 115-a may determine that there are not many NACKs for TBs associated with the high priority, such that a quantity of the high priority buffer space that is used, z0, out of the dedicated portion of the buffer for high priority, Z0, then the remaining portion of the dedicated portion, Z-z0, (e.g., instead of Z−Z0) may be used for the lower priority. That is, the unused portion (z0) of the dedicated portion for the high priority (e.g., Z0) of the buffer (Z) may be reallocated or rededicated to lower priority (Z1 or other priorities), and the amount to reallocate may be determined by Z-z0.

However, in some examples, a dedicated portion for the buffer may be reallocated based on priority even if the dedicated portion is full. For example, a quantity of the buffer space that is used for the low priority, z1, may be greater than the dedicated storage space for Z1 and/or the buffer may be full, such that z1>Z−Z0. When the buffer is full, (z1+20)=Z, or z0=Z−z1, and there is a high priority data or TB that arrives with NACK, a low priority TB may be removed from the soft buffer (e.g., from the used portion of the dedicated low priority portion of the buffer, z1) to vacate storage space for a high priority data or TB (e.g., z0+1 TB, z1−1 TB). This procedure for the dynamic priorities may be performed until z0=Z0. If z1+20=Z, a high priority data or TB may arrive with NACK, and the UE 115-a may remove the low priority buffer, with z1 unchanged. In some cases, Z0=Z, such that high priority data or TB has relatively higher priority than other data or TB, resulting in removing a TB from z1 or removing Z1.

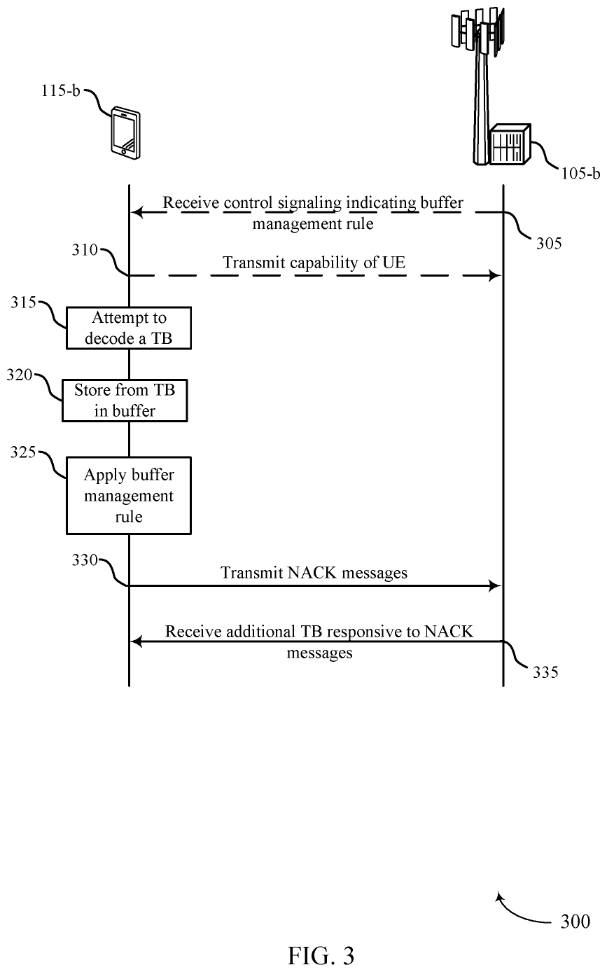

FIG. 3 shows an example of a process flow 300 that supports rule-based soft buffer management in accordance with one or more aspects of the present disclosure. The process flow 300 may implement aspects of or may be implemented by aspects of the wireless communications system 100 or the wireless communications system 200. For example, the process flow 300 may include a UE 115-b and a network entity 105-b, which may be an example of a UE 115 and a network entity 105 as described herein. In the following description of the process flow 300, the operations performed by the UE 115-b and the network entity 105-b may be performed in different orders or at different times than the exemplary order shown. Some operations may also be omitted from the process flow 300, or other operations may be added to the process flow 300. Further, while operations in the process flow 300 are illustrated as being performed by the UE 115-b and the network entity 105-b, the examples herein are not to be construed as limiting, as the described features may be associated with any quantity of different devices.

The network entity 105-b may transmit control signaling indicating the one or more beam management rules or the UE 115-b may transmit signaling indicating the one or more rules. In either case, the network entity 105-b may have knowledge of the one or more rules, enabling the network entity 105-b to make better predictions of the TBs that are stored in the soft buffer and/or removed from the soft buffer of the UE 115-b, and the network entity 105-b may retransmit TBs accordingly.

For example, in some cases, at 305, the UE 115-b may receive control signaling from the network entity 105-b indicating the buffer management rule (e.g., one or more rules) for managing the buffer. In some examples, the buffer management rule may indicate that the buffer is associated with a priority-based storage of TBs, where a purging of individual TBs from the buffer is based on respective priorities of the individual TBs. A buffer storage allocation of the buffer may be allocated based on different priority levels that include at least a first priority level and a second priority level, where a first portion of the buffer is allocated for the first priority level and a second portion of the buffer is allocated for the second priority level.

In some examples, the UE 115-b may receive an indication of the buffer storage allocation indicative of the first portion and the second portion of the buffer. In some examples, the UE 115-a may allocate the buffer storage allocation dynamically between the first portion and the second portion. In some examples, the UE 115-b may receive indications of the respective priorities via respective DCI messages that schedule the individual TBs.

In some examples, the buffer management rule may indicate that the buffer is associated with a buffer size threshold for storage of TBs. The rule may indicate that an individual TB is removed from the buffer based on the buffer size threshold being exceeded and based on a relative time duration of the individual TBs in the buffer with respect to other individual TBs in the buffer.

In some examples, the buffer management rule may indicate that the buffer is associated with a timer-based storage of TBs, and an individual TB may be removed from the buffer after the timer expires for the individual TB. In some examples, the timer may begin at a reference time that is associated with one of receipt of a DCI message that schedules the one or more TBs, transmission of the TB, or an ACK or NACK reporting time for the TB. In some examples, the UE 115-b may receive a value of the timer via an RRC message.

In some examples, at 310, the UE 115-b may transmit a capability of the UE 115-b, where the capability is associated with management of the buffer at the UE 115-b, and where the value of the timer is based on the capability. In some examples, the buffer may include a shared resource pool that is available for storage that pertains to multiple component carriers in carrier aggregation.

At 315, the UE 115-b may attempt to decode a TB received at the UE 115-b from the network entity 105-b. At 320, the UE 115-b may store in the buffer, based on occurrence of a decoding failure during decoding of the TB, information from the TB. At 325, the UE 115-b may apply the buffer management rule to manage capacity of the buffer. The buffer management rule may be common to both the UE and the network entity. At 330, the UE 115-b may transmit one or more NACK messages to the network entity 105-b (e.g., over an uplink shared channel). The one or more NACK messages may be indicative of the decoding failure of the TB. At 335, the UE 115-b may receive an additional TB responsive to the one or more NACK messages and in accordance with the buffer management rule.

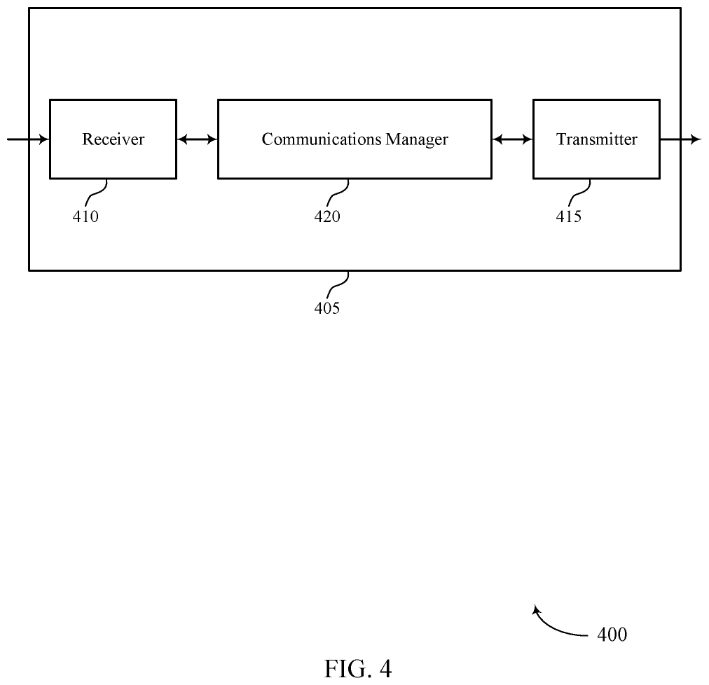

FIG. 4 shows a block diagram 400 of a device 405 that supports rule-based soft buffer management in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, and the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to rule-based soft buffer management). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to rule-based soft buffer management). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of rule-based soft buffer management as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor. If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communication in accordance with examples as disclosed herein. For example, the communications manager 420 is capable of, configured to, or operable to support a means for attempting to decode a TB received at the UE from a network entity. The communications manager 420 is capable of, configured to, or operable to support a means for storing in a buffer, based on occurrence of a decoding failure during decoding of the TB, information from the TB. The communications manager 420 is capable of, configured to, or operable to support a means for applying a buffer management rule to manage capacity of the buffer, where the buffer management rule is common to both the UE and the network entity. The communications manager 420 is capable of, configured to, or operable to support a means for transmitting one or more NACK messages to the network entity, the one or more NACK messages indicative of the decoding failure of the TB. The communications manager 420 is capable of, configured to, or operable to support a means for receiving an additional TB responsive to the one or more NACK messages and in accordance with the buffer management rule.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for enabling the network entity, based on knowledge of the buffer management rule, to more accurately predict and efficiently retransmit the TBs that the UE did not decode or receive in the initial transmission during the HARQ procedure.

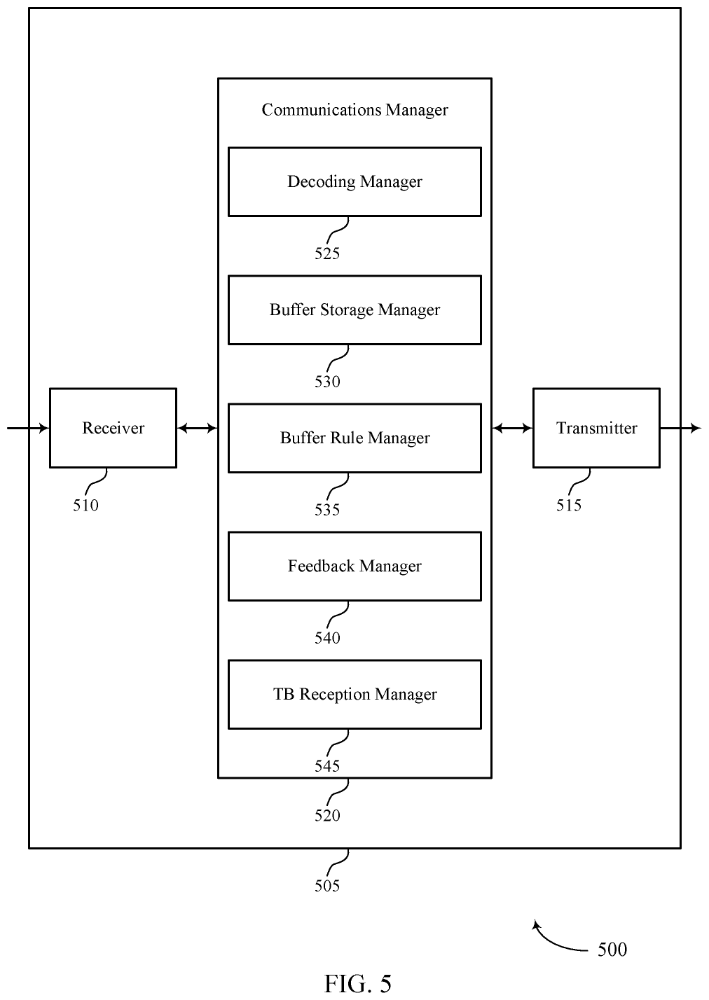

FIG. 5 shows a block diagram 500 of a device 505 that supports rule-based soft buffer management in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to rule-based soft buffer management). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to rule-based soft buffer management). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of rule-based soft buffer management as described herein. For example, the communications manager 520 may include a decoding manager 525, a buffer storage manager 530, a buffer rule manager 535, a feedback manager 540, a TB reception manager 545, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication in accordance with examples as disclosed herein. The decoding manager 525 is capable of, configured to, or operable to support a means for attempting to decode a TB received at the UE from a network entity. The buffer storage manager 530 is capable of, configured to, or operable to support a means for storing in a buffer, based on occurrence of a decoding failure during decoding of the TB, information from the TB. The buffer rule manager 535 is capable of, configured to, or operable to support a means for applying a buffer management rule to manage capacity of the buffer, where the buffer management rule is common to both the UE and the network entity. The feedback manager 540 is capable of, configured to, or operable to support a means for transmitting one or more NACK messages to the network entity, the one or more NACK messages indicative of the decoding failure of the TB. The TB reception manager 545 is capable of, configured to, or operable to support a means for receiving an additional TB responsive to the one or more NACK messages and in accordance with the buffer management rule.

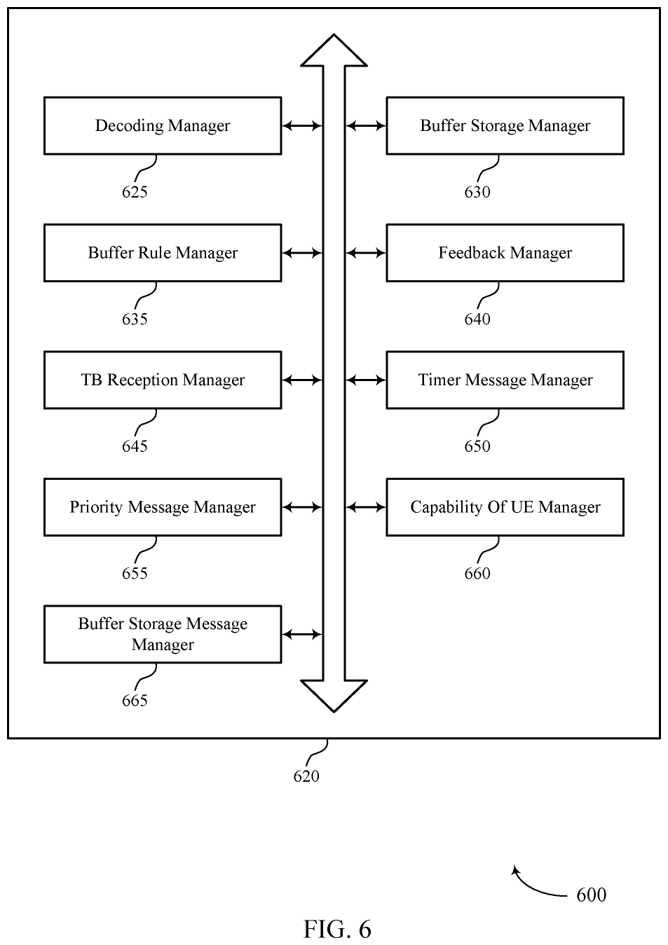

FIG. 6 shows a block diagram 600 of a communications manager 620 that supports rule-based soft buffer management in accordance with one or more aspects of the present disclosure. The communications manager 620 may be an example of aspects of a communications manager 420, a communications manager 520, or both, as described herein. The communications manager 620, or various components thereof, may be an example of means for performing various aspects of rule-based soft buffer management as described herein. For example, the communications manager 620 may include a decoding manager 625, a buffer storage manager 630, a buffer rule manager 635, a feedback manager 640, a TB reception manager 645, a timer message manager 650, a priority message manager 655, a capability of UE manager 660, a buffer storage message manager 665, or any combination thereof. Each of these components, or components or subcomponents thereof (e.g., one or more processors, one or more memories), may communicate, directly or indirectly, with one another (e.g., via one or more buses).

The communications manager 620 may support wireless communication in accordance with examples as disclosed herein. The decoding manager 625 is capable of, configured to, or operable to support a means for attempting to decode a TB received at the UE from a network entity. The buffer storage manager 630 is capable of, configured to, or operable to support a means for storing in a buffer, based on occurrence of a decoding failure during decoding of the TB, information from the TB. The buffer rule manager 635 is capable of, configured to, or operable to support a means for applying a buffer management rule to manage capacity of the buffer, where the buffer management rule is common to both the UE and the network entity. The feedback manager 640 is capable of, configured to, or operable to support a means for transmitting one or more NACK messages to the network entity, the one or more NACK messages indicative of the decoding failure of the TB. The TB reception manager 645 is capable of, configured to, or operable to support a means for receiving an additional TB responsive to the one or more NACK messages and in accordance with the buffer management rule.

In some examples, resources allocated to the buffer include a shared resource pool that is available for storage that pertains to a set of multiple component carriers in carrier aggregation.

In some examples, the buffer management rule indicates that the buffer is associated with a timer-based storage of TBs. In some examples, an individual TB is removed from the buffer after the individual TB.

In some examples, the timer begins at a reference time that is associated with one of receipt of a downlink control information message that schedules the one or more TBs, transmission of the TB, or an ACK or NACK reporting time for the TB.

In some examples, the timer message manager 650 is capable of, configured to, or operable to support a means for receiving a value of the timer via a radio resource configuration (RRC) message.

In some examples, the capability of UE manager 660 is capable of, configured to, or operable to support a means for transmitting a capability of the UE, where the capability is associated with management of the buffer at the UE, and where the value of the timer is based on the capability.

In some examples, the buffer management rule indicates that the buffer is associated with a buffer size threshold for storage of TBs. In some examples, an individual TB is removed from the buffer based on the buffer size threshold being exceeded and based on a relative time duration of the individual TBs in the buffer with respect to other individual TBs in the buffer.

In some examples, the buffer management rule indicates that the buffer is associated with a priority-based storage of TBs, where a purging of individual TBs from the buffer is based on respective priorities of the individual TBs.

In some examples, the priority message manager 655 is capable of, configured to, or operable to support a means for receiving indications of the respective priorities via respective downlink control information messages that schedule the individual TBs.

In some examples, the buffer management rule further indicates that the buffer is associated with a timer-based storage of TBs, where the purging of individual TBs from the buffer is based on a duration of the individual TB in the buffer in combination with the respective priorities.

In some examples, a buffer storage allocation of the buffer is allocated based on different priority levels that include at least a first priority level and a second priority level, where a first portion of the buffer is allocated for the first priority level and a second portion of the buffer is allocated for the second priority level.

In some examples, the buffer storage message manager 665 is capable of, configured to, or operable to support a means for receiving an indication of the buffer storage allocation indicative of the first portion and the second portion.

In some examples, the buffer storage manager 630 is capable of, configured to, or operable to support a means for allocating the buffer storage allocation dynamically between the first portion and the second portion.

In some examples, the buffer rule manager 635 is capable of, configured to, or operable to support a means for receiving control signaling from the network entity indicating the buffer management rule for managing the buffer.

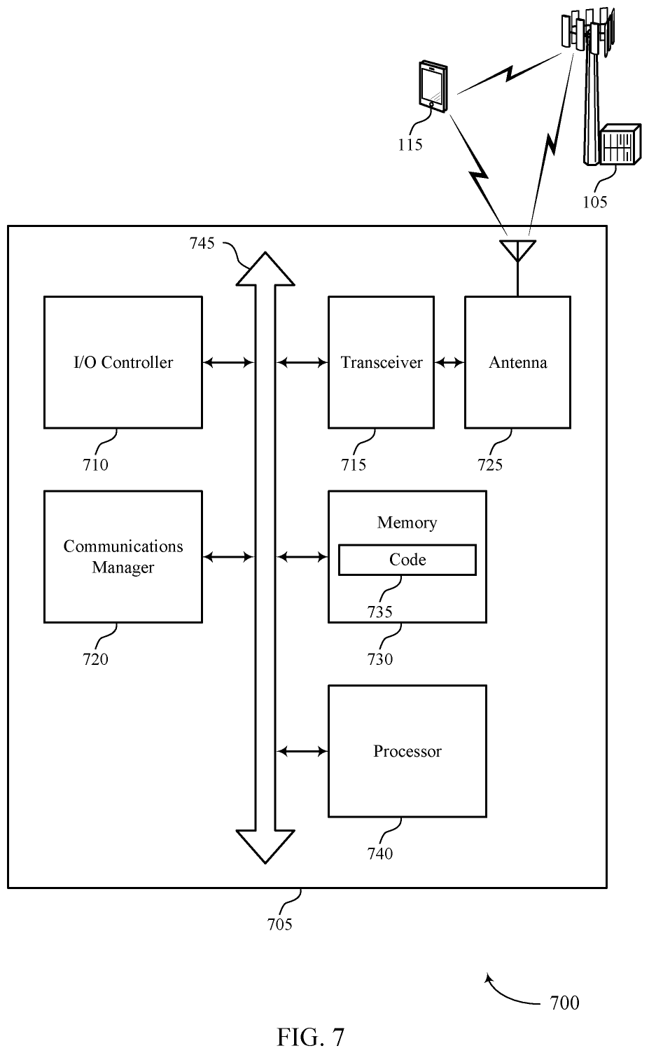

FIG. 7 shows a diagram of a system 700 including a device 705 that supports rule-based soft buffer management in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable code 735 including instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may contain, among other things, a basic I/O system (BIOS) which may control basic hardware or software operation such as the interaction with peripheral components or devices.

The at least one processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting rule-based soft buffer management). For example, the device 705 or a component of the device 705 may include at least one processor 740 and at least one memory 730 coupled with or to the at least one processor 740, the at least one processor 740 and at least one memory 730 configured to perform various functions described herein. In some examples, the at least one processor 740 may include multiple processors and the at least one memory 730 may include multiple memories. One or more of the multiple processors may be coupled with one or more of the multiple memories, which may, individually or collectively, be configured to perform various functions herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. As such, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code stored in the at least one memory 730 or otherwise, to perform one or more of the functions described herein.

The communications manager 720 may support wireless communication in accordance with examples as disclosed herein. For example, the communications manager 720 is capable of, configured to, or operable to support a means for attempting to decode a TB received at the UE from a network entity. The communications manager 720 is capable of, configured to, or operable to support a means for storing in a buffer, based on occurrence of a decoding failure during decoding of the TB, information from the TB. The communications manager 720 is capable of, configured to, or operable to support a means for applying a buffer management rule to manage capacity of the buffer, where the buffer management rule is common to both the UE and the network entity. The communications manager 720 is capable of, configured to, or operable to support a means for transmitting one or more NACK messages to the network entity, the one or more NACK messages indicative of the decoding failure of the TB. The communications manager 720 is capable of, configured to, or operable to support a means for receiving an additional TB responsive to the one or more NACK messages and in accordance with the buffer management rule.

By including or configuring the communications manager 720 in accordance with examples as described herein, the device 705 may support techniques for enabling the network entity, based on knowledge of the buffer management rule, to more accurately predict and efficiently retransmit the TBs that the UE did not decode or receive in the initial transmission during the HARQ procedure.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of rule-based soft buffer management as described herein, or the at least one processor 740 and the at least one memory 730 may be otherwise configured to, individually or collectively, perform or support such operations.

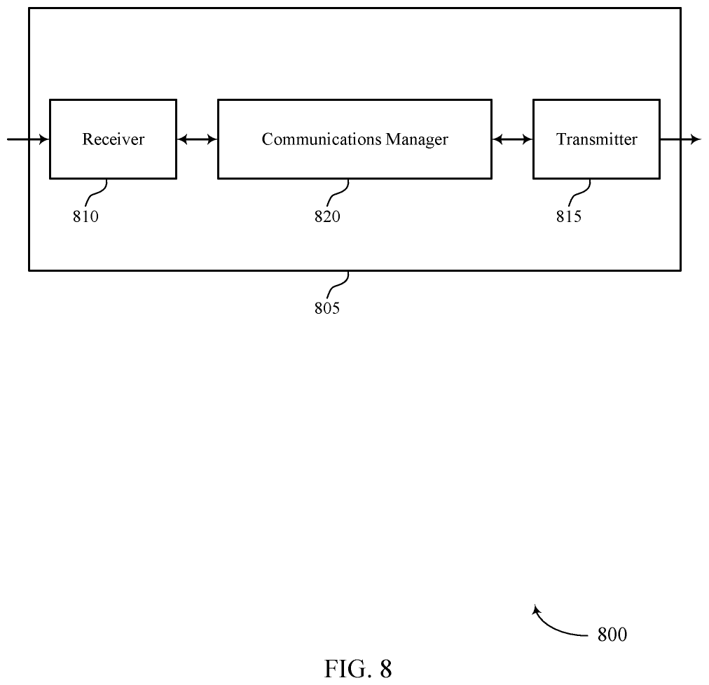

FIG. 8 shows a block diagram 800 of a device 805 that supports rule-based soft buffer management in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, and the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of rule-based soft buffer management as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor. If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication in accordance with examples as disclosed herein. For example, the communications manager 820 is capable of, configured to, or operable to support a means for transmitting a TB to a UE over a downlink shared channel. The communications manager 820 is capable of, configured to, or operable to support a means for receiving one or more NACK messages (e.g., over an uplink shared channel), the one or more NACK messages associated with the TB. The communications manager 820 is capable of, configured to, or operable to support a means for determining, based on receipt of the one or more NACK messages, that information from the TB is stored at a buffer at the UE based on a buffer management rule that is common to both the network entity and the UE. The communications manager 820 is capable of, configured to, or operable to support a means for transmitting, to the UE, an additional TB responsive to the one or more NACK messages and in accordance with the buffer management rule.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for enabling the network entity, based on knowledge of the buffer management rule, to more accurately predict and efficiently retransmit the TBs that the UE did not decode or receive in the initial transmission during the HARQ procedure.

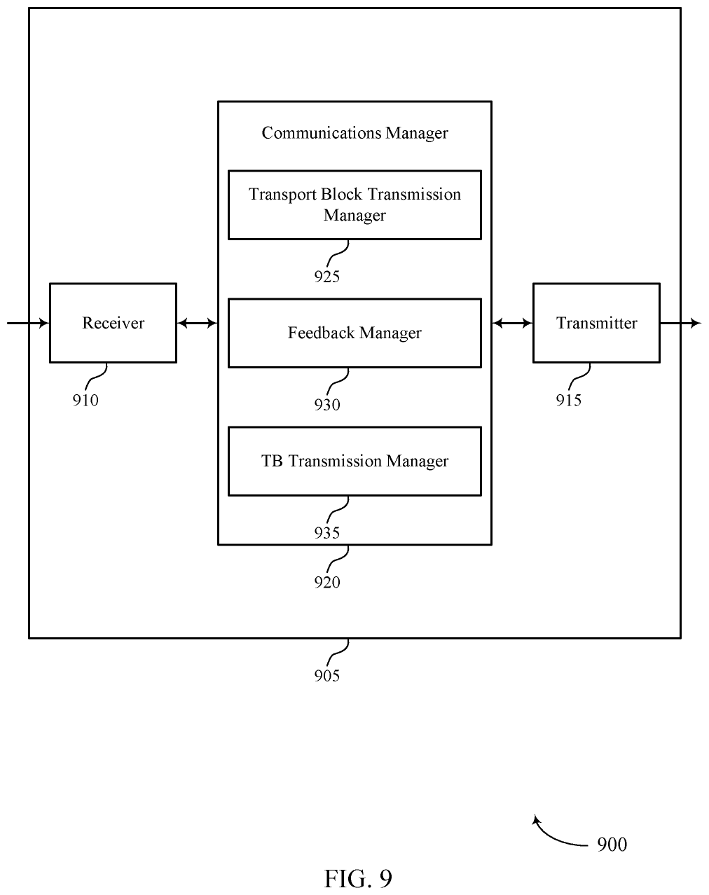

FIG. 9 shows a block diagram 900 of a device 905 that supports rule-based soft buffer management in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of rule-based soft buffer management as described herein. For example, the communications manager 920 may include a TB transmission manager 925, a feedback manager 930, a TB transmission manager 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication in accordance with examples as disclosed herein. The TB transmission manager 925 is capable of, configured to, or operable to support a means for transmitting a TB to a UE over a downlink shared channel. The feedback manager 930 is capable of, configured to, or operable to support a means for receiving one or more NACK messages, the one or more NACK messages associated with the TB. The feedback manager 930 is capable of, configured to, or operable to support a means for determining, based on receipt of the one or more NACK messages, that information from the TB is stored at a buffer at the UE based on a buffer management rule that is common to both the network entity and the UE. The TB transmission manager 935 is capable of, configured to, or operable to support a means for transmitting, to the UE, an additional TB responsive to the one or more NACK messages and in accordance with the buffer management rule.

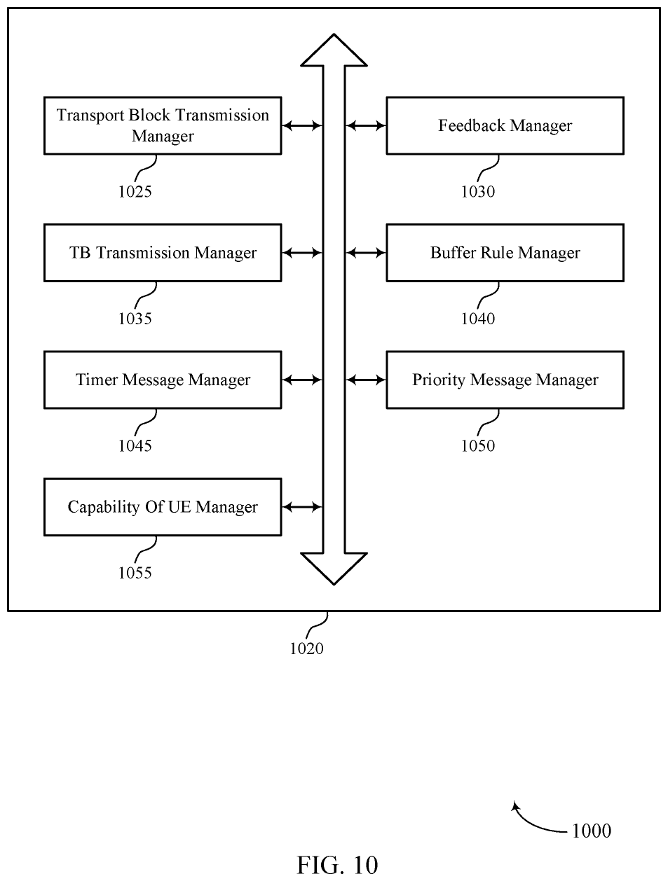

FIG. 10 shows a block diagram 1000 of a communications manager 1020 that supports rule-based soft buffer management in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of rule-based soft buffer management as described herein. For example, the communications manager 1020 may include a TB transmission manager 1025, a feedback manager 1030, a TB transmission manager 1035, a buffer rule manager 1040, a timer message manager 1045, a priority message manager 1050, a capability of UE manager 1055, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communication in accordance with examples as disclosed herein. The TB transmission manager 1025 is capable of, configured to, or operable to support a means for transmitting a TB to a UE over a downlink shared channel. The feedback manager 1030 is capable of, configured to, or operable to support a means for receiving one or more NACK messages, the one or more NACK messages associated with the TB. In some examples, the feedback manager 1030 is capable of, configured to, or operable to support a means for determining, based on receipt of the one or more NACK messages, that information from the TB is stored at a buffer at the UE based on a buffer management rule that is common to both the network entity and the UE. The TB transmission manager 1035 is capable of, configured to, or operable to support a means for transmitting, to the UE, an additional TB responsive to the one or more NACK messages and in accordance with the buffer management rule.

In some examples, the buffer management rule indicates that the buffer is associated with a timer-based storage of TBs, where purging of the buffer is based on a duration of individual TBs in the buffer with respect to a timer.

In some examples, the timer message manager 1045 is capable of, configured to, or operable to support a means for transmitting a value of the timer via a radio resource configuration (RRC) message.

In some examples, the capability of UE manager 1055 is capable of, configured to, or operable to support a means for receiving a capability of the UE, where the capability is associated with management of the buffer at the UE, and where the value of the timer is based on the capability.

In some examples, the buffer management rule indicates that the buffer is associated with a buffer size threshold for storage of TBs, where purging of the buffer is based on the buffer size threshold being exceeded and based on a relative duration of individual TBs in the buffer with respect to other individual TBs in the buffer.

In some examples, the buffer management rule indicates that the buffer is associated with a priority-based storage of TBs, where a purging of individual TBs from the buffer is based on respective priorities of the individual TBs.

In some examples, the priority message manager 1050 is capable of, configured to, or operable to support a means for transmitting indications of the respective priorities via respective downlink control information messages that schedule the individual TBs.

In some examples, the buffer management rule further indicates that the buffer is associated with a timer-based storage of TBs, where the purging of individual TBs from the buffer is based on a duration of the individual TBs in the buffer in combination with the respective priorities.

In some examples, a buffer storage allocation of the buffer is allocated based on different priority levels that include at least a first priority level and a second priority level, where a first portion of the buffer is allocated for the first priority level and a second portion of the buffer is allocated for the second priority level.

In some examples, the buffer rule manager 1040 is capable of, configured to, or operable to support a means for transmitting an indication of the buffer storage allocation indicative of the first portion and the second portion.

In some examples, the buffer rule manager 1040 is capable of, configured to, or operable to support a means for transmitting control signaling from the network entity indicating the buffer management rule for managing the buffer.

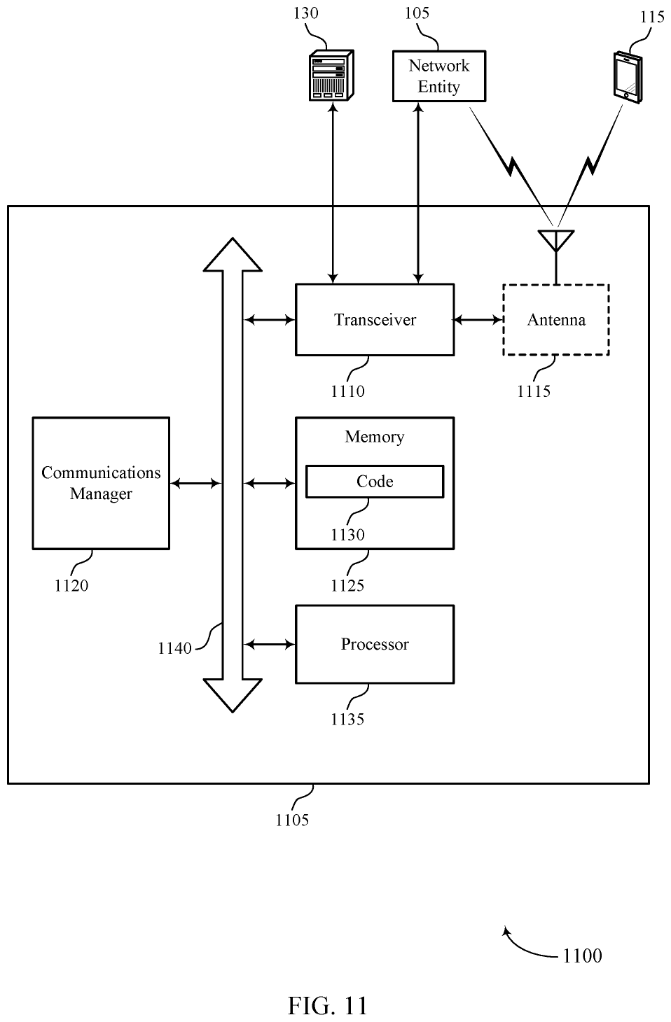

FIG. 11 shows a diagram of a system 1100 including a device 1105 that supports rule-based soft buffer management in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., a communication link 125, a backhaul communication link 120, a midhaul communication link 162, a fronthaul communication link 168).

The at least one memory 1125 may include RAM, ROM, or any combination thereof. The at least one memory 1125 may store computer-readable, computer-executable code 1130 including instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may contain, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting rule-based soft buffer management). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125). In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. As such, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communication in accordance with examples as disclosed herein. For example, the communications manager 1120 is capable of, configured to, or operable to support a means for transmitting a TB to a UE over a downlink shared channel. The communications manager 1120 is capable of, configured to, or operable to support a means for receiving one or more NACK messages, the one or more NACK messages associated with the TB. The communications manager 1120 is capable of, configured to, or operable to support a means for determining, based on receipt of the one or more NACK messages, that information from the TB is stored at a buffer at the UE based on a buffer management rule that is common to both the network entity and the UE. The communications manager 1120 is capable of, configured to, or operable to support a means for transmitting, to the UE, an additional TB responsive to the one or more NACK messages and in accordance with the buffer management rule.

By including or configuring the communications manager 1120 in accordance with examples as described herein, the device 1105 may support techniques for enabling the network entity, based on knowledge of the buffer management rule, to more accurately predict and efficiently retransmit the TBs that the UE did not decode or receive in the initial transmission during the HARQ procedure.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of rule-based soft buffer management as described herein, or the at least one processor 1135 and the at least one memory 1125 may be otherwise configured to, individually or collectively, perform or support such operations.

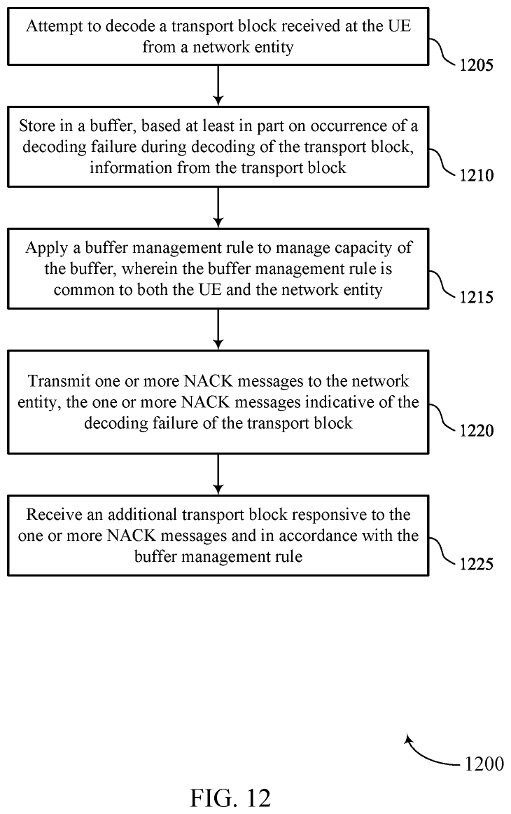

FIG. 12 shows a flowchart illustrating a method 1200 that supports rule-based soft buffer management in accordance with aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include attempting to decode a TB received at the UE from a network entity. The operations of block 1205 may be performed in accordance with examples as disclosed herein. In some examples, aspects of the operations of 1205 may be performed by a decoding manager 625 as described with reference to FIG. 6.

At 1210, the method may include storing in a buffer, based on occurrence of a decoding failure during decoding of the TB, information from the TB. The operations of block 1210 may be performed in accordance with examples as disclosed herein. In some examples, aspects of the operations of 1210 may be performed by a buffer storage manager 630 as described with reference to FIG. 6.

At 1215, the method may include applying a buffer management rule to manage capacity of the buffer, where the buffer management rule is common to both the UE and the network entity. The operations of block 1215 may be performed in accordance with examples as disclosed herein. In some examples, aspects of the operations of 1215 may be performed by a buffer rule manager 635 as described with reference to FIG. 6.

At 1220, the method may include transmitting one or more NACK messages to the network entity, the one or more NACK messages indicative of the decoding failure of the TB. The operations of block 1220 may be performed in accordance with examples as disclosed herein. In some examples, aspects of the operations of 1220 may be performed by a feedback manager 640 as described with reference to FIG. 6.

At 1225, the method may include receiving an additional TB responsive to the one or more NACK messages and in accordance with the buffer management rule. The operations of block 1225 may be performed in accordance with examples as disclosed herein. In some examples, aspects of the operations of 1225 may be performed by a TB reception manager 645 as described with reference to FIG. 6.

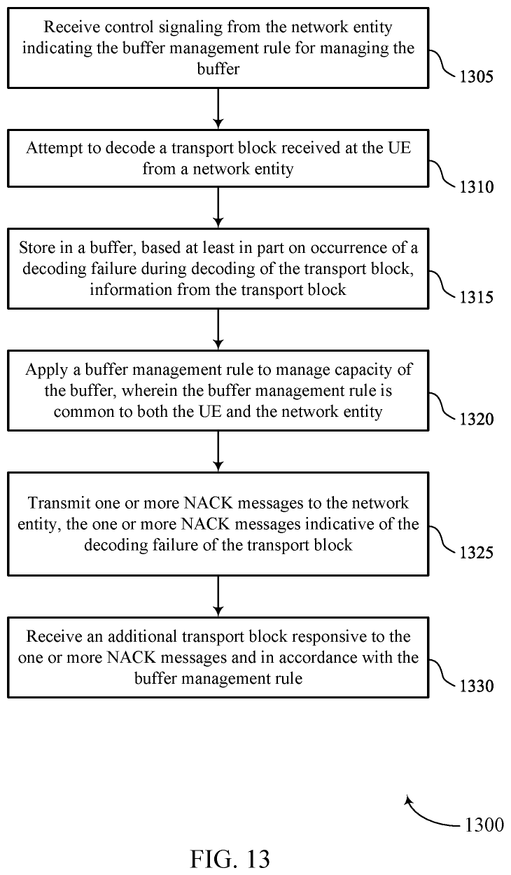

FIG. 13 shows a flowchart illustrating a method 1300 that supports rule-based soft buffer management in accordance with aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving control signaling from the network entity indicating the buffer management rule for managing the buffer. The operations of block 1305 may be performed in accordance with examples as disclosed herein. In some examples, aspects of the operations of 1305 may be performed by a buffer rule manager 635 as described with reference to FIG. 6.

At 1310, the method may include attempting to decode a TB received at the UE from a network entity. The operations of block 1310 may be performed in accordance with examples as disclosed herein. In some examples, aspects of the operations of 1310 may be performed by a decoding manager 625 as described with reference to FIG. 6.

At 1315, the method may include storing in a buffer, based on occurrence of a decoding failure during decoding of the TB, information from the TB. The operations of block 1315 may be performed in accordance with examples as disclosed herein. In some examples, aspects of the operations of 1315 may be performed by a buffer storage manager 630 as described with reference to FIG. 6.

At 1320, the method may include applying a buffer management rule to manage capacity of the buffer, where the buffer management rule is common to both the UE and the network entity. The operations of block 1320 may be performed in accordance with examples as disclosed herein. In some examples, aspects of the operations of 1320 may be performed by a buffer rule manager 635 as described with reference to FIG. 6.

At 1325, the method may include transmitting one or more NACK messages to the network entity, the one or more NACK messages indicative of the decoding failure of the TB. The operations of block 1325 may be performed in accordance with examples as disclosed herein. In some examples, aspects of the operations of 1325 may be performed by a feedback manager 640 as described with reference to FIG. 6.

At 1330, the method may include receiving an additional TB responsive to the one or more NACK messages and in accordance with the buffer management rule. The operations of block 1330 may be performed in accordance with examples as disclosed herein. In some examples, aspects of the operations of 1330 may be performed by a TB reception manager 645 as described with reference to FIG. 6.

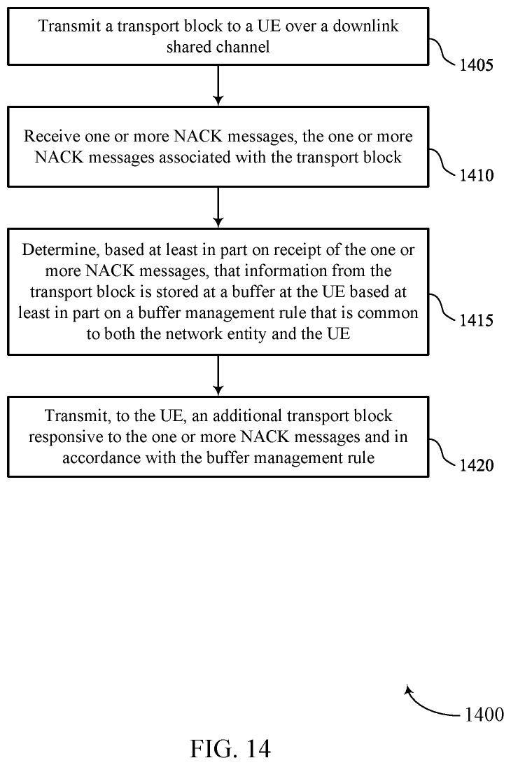

FIG. 14 shows a flowchart illustrating a method 1400 that supports rule-based soft buffer management in accordance with aspects of the present disclosure. The operations of the method 1400 may be implemented by a network entity or its components as described herein. For example, the operations of the method 1400 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1405, the method may include transmitting a TB to a UE over a downlink shared channel. The operations of block 1405 may be performed in accordance with examples as disclosed herein. In some examples, aspects of the operations of 1405 may be performed by a TB transmission manager 1025 as described with reference to FIG. 10.

At 1410, the method may include receiving one or more NACK messages, the one or more NACK messages associated with the TB. The operations of block 1410 may be performed in accordance with examples as disclosed herein. In some examples, aspects of the operations of 1410 may be performed by a feedback manager 1030 as described with reference to FIG. 10.

At 1415, the method may include determining, based on receipt of the one or more NACK messages, that information from the TB is stored at a buffer at the UE based on a buffer management rule that is common to both the network entity and the UE. The operations of block 1415 may be performed in accordance with examples as disclosed herein. In some examples, aspects of the operations of 1415 may be performed by a feedback manager 1030 as described with reference to FIG. 10.

At 1420, the method may include transmitting, to the UE, an additional TB responsive to the one or more NACK messages and in accordance with the buffer management rule. The operations of block 1420 may be performed in accordance with examples as disclosed herein. In some examples, aspects of the operations of 1420 may be performed by a TB transmission manager 1035 as described with reference to FIG. 10.

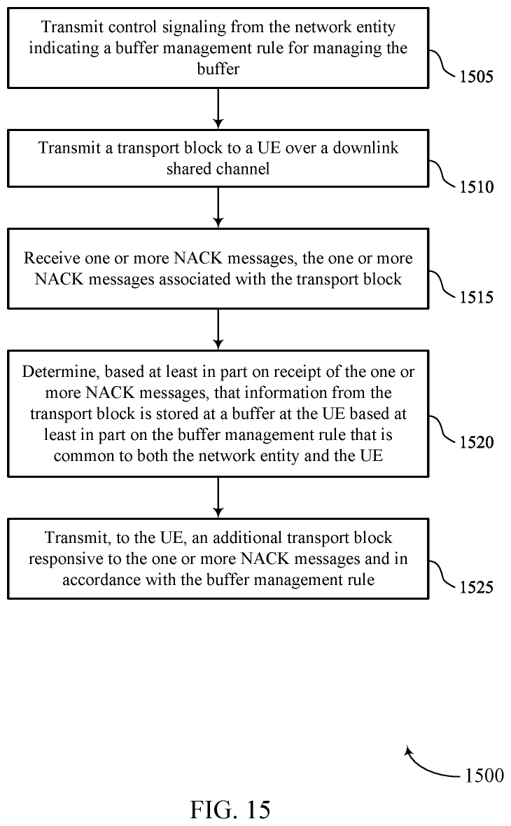

FIG. 15 shows a flowchart illustrating a method 1500 that supports rule-based soft buffer management in accordance with aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include transmitting control signaling from the network entity indicating the buffer management rule for managing the buffer. The operations of block 1505 may be performed in accordance with examples as disclosed herein. In some examples, aspects of the operations of 1505 may be performed by a buffer rule manager 1040 as described with reference to FIG. 10.

At 1510, the method may include transmitting a TB to a UE over a downlink shared channel. The operations of block 1510 may be performed in accordance with examples as disclosed herein. In some examples, aspects of the operations of 1510 may be performed by a TB transmission manager 1025 as described with reference to FIG. 10.

At 1515, the method may include receiving one or more NACK messages, the one or more NACK messages associated with the TB. The operations of block 1515 may be performed in accordance with examples as disclosed herein. In some examples, aspects of the operations of 1515 may be performed by a feedback manager 1030 as described with reference to FIG. 10.

At 1520, the method may include determining, based on receipt of the one or more NACK messages, that information from the TB is stored at a buffer at the UE based on a buffer management rule that is common to both the network entity and the UE. The operations of block 1520 may be performed in accordance with examples as disclosed herein. In some examples, aspects of the operations of 1520 may be performed by a feedback manager 1030 as described with reference to FIG. 10.

At 1525, the method may include transmitting, to the UE, an additional TB responsive to the one or more NACK messages and in accordance with the buffer management rule. The operations of block 1525 may be performed in accordance with examples as disclosed herein. In some examples, aspects of the operations of 1525 may be performed by a TB transmission manager 1035 as described with reference to FIG. 10.

The following provides an overview of aspects of the present disclosure:
Aspect 1: A method for wireless communication at a UE, comprising: attempting to decode a TB received at the UE from a network entity; storing in a buffer, based at least in part on occurrence of a decoding failure during decoding of the TB, information from the TB; applying a buffer management rule to manage capacity of the buffer, wherein the buffer management rule is common to both the UE and the network entity; transmitting one or more NACK messages to the network entity, the one or more NACK messages indicative of the decoding failure of the TB; and receiving an additional TB responsive to the one or more NACK messages and in accordance with the buffer management rule.
Aspect 2: The method of aspect 1, wherein resources allocated to the buffer include a shared resource pool that is available for storage that pertains to a plurality of component carriers in carrier aggregation.
Aspect 3: The method of any of aspects 1 through 2, wherein the buffer management rule indicates that the buffer is associated with a timer-based storage of TBs, and an individual TB is removed from the buffer after the timer expires for the individual TB.
Aspect 4: The method of aspect 3, wherein the timer begins at a reference time that is associated with one of receipt of a downlink control information message that schedules the one or more TBs, transmission of the TB, or an ACK or NACK reporting time for the TB.
Aspect 5: The method of any of aspects 3 through 4, further comprising: receiving a value of the timer via a RRC message.
Aspect 6: The method of aspect 5, further comprising: transmitting a capability of the UE, wherein the capability is associated with management of the buffer at the UE, and wherein the value of the timer is based at least in part on the capability.
Aspect 7: The method of any of aspects 1 through 6, wherein the buffer management rule indicates that the buffer is associated with a buffer size threshold for storage of TBs, and an individual TB is removed from the buffer based on the buffer size threshold being exceeded and based on a relative time duration of the individual TBs in the buffer with respect to other individual TBs in the buffer.
Aspect 8: The method of any of aspects 1 through 7, wherein the buffer management rule indicates that the buffer is associated with a priority-based storage of TBs, wherein a purging of individual TBs from the buffer is based at least in part on respective priorities of the individual TBs.
Aspect 9: The method of aspect 8, further comprising: receiving indications of the respective priorities via respective downlink control information messages that schedule the individual TBs.
Aspect 10: The method of any of aspects 8 through 9, wherein the buffer management rule further indicates that the buffer is associated with a timer-based storage of TBs, wherein the purging of individual TBs from the buffer is based at least in part on a duration of the individual TB in the buffer in combination with the respective priorities.
Aspect 11: The method of any of aspects 8 through 10, wherein a buffer storage allocation of the buffer is allocated based at least in part on different priority levels that include at least a first priority level and a second priority level, wherein a first portion of the buffer is allocated for the first priority level and a second portion of the buffer is allocated for the second priority level.
Aspect 12: The method of aspect 11, further comprising: receiving an indication of the buffer storage allocation indicative of the first portion and the second portion.
Aspect 13: The method of any of aspects 11 through 12, further comprising: allocating the buffer storage allocation dynamically between the first portion and the second portion.
Aspect 14: The method of any of aspects 1 through 13, further comprising: receiving control signaling from the network entity indicating the buffer management rule for managing the buffer.
Aspect 15: A method for wireless communication at a network entity, comprising: transmitting a TB to a UE over a downlink shared channel; receiving one or more NACK messages, the one or more NACK messages associated with the TB; determining, based at least in part on receipt of the one or more NACK messages, that information from the TB is stored at a buffer at the UE based at least in part on a buffer management rule that is common to both the network entity and the UE; an transmitting, to the UE, an additional TB responsive to the one or more NACK messages and in accordance with the buffer management rule.
Aspect 16: The method of aspect 15, wherein the buffer management rule indicates that the buffer is associated with a timer-based storage of TBs, wherein purging of the buffer is based on a duration of individual TBs in the buffer with respect to a timer.
Aspect 17: The method of aspect 16, further comprising: transmitting a value of the timer via a RRC message.
Aspect 18: The method of aspect 17, further comprising: receiving a capability of the UE, wherein the capability is associated with management of the buffer at the UE, and wherein the value of the timer is based at least in part on the capability.
Aspect 19: The method of any of aspects 15 through 18, wherein the buffer management rule indicates that the buffer is associated with a buffer size threshold for storage of TBs, wherein purging of the buffer is based on the buffer size threshold being exceeded and based on a relative time duration of individual TBs in the buffer with respect to other individual TBs in the buffer.
Aspect 20: The method of any of aspects 15 through 19, wherein the buffer management rule indicates that the buffer is associated with a priority-based storage of TBs, wherein a purging of individual TBs from the buffer is based at least in part on respective priorities of the individual TBs.
Aspect 21: The method of aspect 20, further comprising: transmitting indications of the respective priorities via respective downlink control information messages that schedule the individual TBs.
Aspect 22: The method of any of aspects 20 through 21, wherein the buffer management rule further indicates that the buffer is associated with a timer-based storage of TBs, wherein the purging of individual TBs from the buffer is based at least in part on a duration of the individual TBs in the buffer in combination with the respective priorities.
Aspect 23: The method of any of aspects 20 through 22, wherein a buffer storage allocation of the buffer is allocated based at least in part on different priority levels that include at least a first priority level and a second priority level, wherein a first portion of the buffer is allocated for the first priority level and a second portion of the buffer is allocated for the second priority level.
Aspect 24: The method of aspect 23, further comprising: transmitting an indication of the buffer storage allocation indicative of the first portion and the second portion.
Aspect 25: The method of any of aspects 15 through 24, further comprising: transmitting control signaling from the network entity indicating the buffer management rule for managing the buffer.
Aspect 26: A UE for wireless communication, comprising one or more memories storing processor-executable code, and one or more processors coupled with the one or more memories and individually or collectively operable to execute the code to cause the UE to perform a method of any of aspects 1 through 14.
Aspect 27: A UE for wireless communication, comprising at least one means for performing a method of any of aspects 1 through 14.
Aspect 28: A non-transitory computer-readable medium storing code for wireless communication, the code comprising instructions executable by one or more processors to perform a method of any of aspects 1 through 14.
Aspect 29: A network entity for wireless communication, comprising one or more memories storing processor-executable code, and one or more processors coupled with the one or more memories and individually or collectively operable to execute the code to cause the network entity to perform a method of any of aspects 15 through 25.
Aspect 30: A network entity for wireless communication, comprising at least one means for performing a method of any of aspects 15 through 25.
Aspect 31: A non-transitory computer-readable medium storing code for wireless communication, the code comprising instructions executable by one or more processors to perform a method of any of aspects 15 through 25.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
attempt to decode a transport block received at the UE from a network entity;
store in a buffer, based at least in part on occurrence of a decoding failure during decoding of the transport block, information from the transport block;
apply a buffer management rule to manage capacity of the buffer, wherein the buffer management rule is common to both the UE and the network entity;
transmit one or more negative acknowledgment (NACK) messages to the network entity, the one or more NACK messages indicative of the decoding failure of the transport block; and
receive an additional transport block responsive to the one or more NACK messages and in accordance with the buffer management rule.

2. The UE of claim 1, wherein resources allocated to the buffer include a shared resource pool that is available for storage that pertains to a plurality of component carriers in carrier aggregation.

3. The UE of claim 1, wherein:
the buffer management rule indicates that the buffer is associated with a timer-based storage of transport blocks, and
an individual transport block is removed from the buffer after a timer expires for the individual transport block.

4. The UE of claim 3, wherein the timer begins at a reference time that is associated with one of receipt of a downlink control information message that schedules the transport block, transmission of the transport block, or an acknowledgment (ACK) or NACK reporting time for the transport block.

5. The UE of claim 3, wherein the one or more processors are individually or collectively further operable to execute the code to cause the UE to:
receive a value of the timer via a radio resource configuration (RRC) message.

6. The UE of claim 5, wherein the one or more processors are individually or collectively further operable to execute the code to cause the UE to:
transmit a capability of the UE, wherein the capability is associated with management of the buffer at the UE, and wherein the value of the timer is based at least in part on the capability.

7. The UE of claim 1, wherein:
the buffer management rule indicates that the buffer is associated with a buffer size threshold for storage of transport blocks, and
an individual transport block is removed from the buffer based on the buffer size threshold being exceeded and based on a relative time duration of the individual transport block in the buffer with respect to other individual transport blocks in the buffer.

8. The UE of claim 1, wherein the buffer management rule indicates that the buffer is associated with a priority-based storage of transport blocks, wherein a purging of individual transport blocks from the buffer is based at least in part on respective priorities of the individual transport blocks.

9. The UE of claim 8, wherein the one or more processors are individually or collectively further operable to execute the code to cause the UE to:
receive indications of the respective priorities via respective downlink control information messages that schedule the individual transport blocks.

10. The UE of claim 8, wherein the buffer management rule further indicates that the buffer is associated with a timer-based storage of transport blocks, wherein the purging of individual transport blocks from the buffer is based at least in part on a duration of the individual transport blocks in the buffer in combination with the respective priorities.

11. The UE of claim 8, wherein a buffer storage allocation of the buffer is allocated based at least in part on different priority levels that include at least a first priority level and a second priority level, wherein a first portion of the buffer is allocated for the first priority level and a second portion of the buffer is allocated for the second priority level.

12. The UE of claim 11, wherein the one or more processors are individually or collectively further operable to execute the code to cause the UE to:
receive an indication of the buffer storage allocation indicative of the first portion and the second portion.

13. The UE of claim 11, wherein the one or more processors are individually or collectively further operable to execute the code to cause the UE to:
allocate the buffer storage allocation dynamically between the first portion and the second portion.

14. The UE of claim 1, wherein the one or more processors are individually or collectively further operable to execute the code to cause the UE to:
receive control signaling from the network entity indicating the buffer management rule for managing the buffer.

15. A network entity, comprising:
one or more memories storing processor-executable code; and
one or more processors coupled with the one or more memories and individually or collectively operable to execute the code to cause the network entity to:
transmit a transport block to a user equipment (UE) over a downlink shared channel;
receive one or more negative acknowledgment (NACK) messages, the one or more NACK messages associated with the transport block;
determine, based at least in part on receipt of the one or more NACK messages, that information from the transport block is stored at a buffer at the UE based at least in part on a buffer management rule that is common to both the network entity and the UE; and
transmit, to the UE, an additional transport block responsive to the one or more NACK messages and in accordance with the buffer management rule.

16. The network entity of claim 15, wherein the buffer management rule indicates that the buffer is associated with a timer-based storage of transport blocks, wherein purging of the buffer is based on a duration of individual transport blocks in the buffer with respect to a timer.

17. The network entity of claim 16, wherein the one or more processors are individually or collectively further operable to execute the code to cause the network entity to:
transmit a value of the timer via a radio resource configuration (RRC) message.

18. The network entity of claim 17, wherein the one or more processors are individually or collectively further operable to execute the code to cause the network entity to:
receive a capability of the UE, wherein the capability is associated with management of the buffer at the UE, and wherein the value of the timer is based at least in part on the capability.

19. The network entity of claim 15, wherein the buffer management rule indicates that the buffer is associated with a buffer size threshold for storage of transport blocks, wherein purging of the buffer is based on the buffer size threshold being exceeded and based on a relative duration of individual transport blocks in the buffer with respect to other individual transport blocks in the buffer.

20. The network entity of claim 15, wherein the buffer management rule indicates that the buffer is associated with a priority-based storage of transport blocks, wherein a purging of individual transport blocks from the buffer is based at least in part on respective priorities of the individual transport blocks.

21. The network entity of claim 20, wherein the one or more processors are individually or collectively further operable to execute the code to cause the network entity to:
transmit indications of the respective priorities via respective downlink control information messages that schedule the individual transport blocks.

22. The network entity of claim 20, wherein the buffer management rule further indicates that the buffer is associated with a timer-based storage of transport blocks, wherein the purging of individual transport blocks from the buffer is based at least in part on a duration of the individual transport blocks in the buffer in combination with the respective priorities.

23. The network entity of claim 20, wherein a buffer storage allocation of the buffer is allocated based at least in part on different priority levels that include at least a first priority level and a second priority level, wherein a first portion of the buffer is allocated for the first priority level and a second portion of the buffer is allocated for the second priority level.

24. The network entity of claim 23, wherein the one or more processors are individually or collectively further operable to execute the code to cause the network entity to:
transmit an indication of the buffer storage allocation indicative of the first portion and the second portion.

25. The network entity of claim 15, wherein the one or more processors are individually or collectively further operable to execute the code to cause the network entity to:
transmit control signaling from the network entity indicating the buffer management rule for managing the buffer.

26. A method for wireless communication at a user equipment (UE), comprising:
attempting to decode a transport block received at the UE from a network entity;
storing in a buffer, based at least in part on occurrence of a decoding failure during decoding of the transport block, information from the transport block;
applying a buffer management rule to manage capacity of the buffer, wherein the buffer management rule is common to both the UE and the network entity;
transmitting one or more negative acknowledgment (NACK) messages to the network entity, the one or more NACK messages indicative of the decoding failure of the transport block; and
receiving an additional transport block responsive to the one or more NACK messages and in accordance with the buffer management rule.

27. The method of claim 26, wherein:
the buffer management rule indicates that the buffer is associated with a timer-based storage of transport blocks, and
an individual transport block is removed from the buffer after a timer expires for the individual transport block.

28. A method for wireless communication at a network entity, comprising:
transmitting a transport block to a user equipment (UE) over a downlink shared channel;
receiving one or more negative acknowledgment (NACK) messages, the one or more NACK messages associated with the transport block;
determining, based at least in part on receipt of the one or more NACK messages, that information from the transport block is stored at a buffer at the UE based at least in part on a buffer management rule that is common to both the network entity and the UE; and
transmitting, to the UE, an additional transport block responsive to the one or more NACK messages and in accordance with the buffer management rule.

29. The method of claim 28, wherein the buffer management rule indicates that the buffer is associated with a buffer size threshold for storage of transport blocks, wherein purging of the buffer is based on the buffer size threshold being exceeded and based on a relative duration of individual transport blocks in the buffer with respect to other individual transport blocks in the buffer.

30. The method of claim 28, wherein the buffer management rule indicates that the buffer is associated with a priority-based storage of transport blocks, wherein a purging of individual transport blocks from the buffer is based at least in part on respective priorities of the individual transport blocks.
